(19) United States
(12) Patent Application Publication
(10) Pub. No.: US 2026/0322184 A1
(43) Pub. Date: Oct. 15, 2026

(54) MULTIFUNCTIONAL ELECTRONIC DEVICE HOLDER

(71) Applicant: COMART CORPORATION, New Taipei City (TW)

(72) Inventors: Su-Wei LIU, Taipei (TW); TIEGANG FENG, Shenzhen (CN)

(73) Assignee: COMART CORPORATION, New Taipei City (TW)

(21) Appl. No.: 19/539,671

(22) Filed: Feb. 13, 2026

(30) Foreign Application Priority Data
Apr. 10, 2025 (TW) 114203565

(51) Int. Cl. H02J 50/90; H02J 7/50; H02J 50/40

(52) U.S. Cl. CPC H02J 50/90; H02J 7/50; H02J 50/40

(57) ABSTRACT

A multifunctional electronic device holder includes a first carrier board and a second carrier board. The first and second carrier boards are respectively provided with corresponding angled inclined surfaces that abut against each other and are pivotally connected. This design allows the first carrier board to rotate relative to the second carrier board and be positioned securely, and provides either a planar support mode or an elevation-angle support mode to charge and magnetically position different external electronic devices, or to tilt an electronic device to enhance the flexibility of use.

### TECHNICAL FIELD OF THE DISCLOSURE

The present disclosure relates to a multifunctional electronic device holder, which includes two carrier boards that can pivot relative to each other in a planar support mode or an elevation-angle support mode to allow different external electronic devices to be magnetically positioned at multiple angles and/or wirelessly charged to enhance the flexibility of use.

### DESCRIPTION OF RELATED ART

With the rapid advancement of technology, various innovative electronic devices have been developed and introduced, making our lives more convenient and comfortable. Examples of electronic devices include smartphones, Bluetooth headphones, smartwatches, satellite navigation systems, etc. While using the electronic devices, these device are also gradually transforming our lifestyles. For example, the limited battery capacity of the electronic devices has made “charging” an indispensable daily routine for modern individuals.

Taking smartphones as an example, charging modules equipped with magnetic elements and wireless charging protocols (Qi) are gradually becoming standard equipment. Consequently, many manufacturers are designing compatible peripherals such as wireless charging stands and magnetic stands to allow the smartphones to be magnetically positioned and charged at any time during idle or use.

However, conventional mobile phone holders or wireless charging pads available on the market offer limited functionality, and fail to meet diverse and versatile needs across various usage scenarios. For example, an electronic device holder as disclosed in R.O.C. Utility Model No. M455322 includes a base and a support bracket. The base and support bracket can be rotated relative to each other to form either a flat surface state or an inclined support surface state. The flat surface state facilitates storage, while the inclined support surface allows electronic devices to rest at an angle against the holder for easier viewing.

Although the R.O.C. Utility Model No. M455322 offers two operational modes, it lacks a positioning design for switching between the two operational modes, thus resulting in potential arbitrary deflection between the base and support bracket when moving the holder, causing

electronic devices resting at an angle on the holder to easily fall and be damaged, and presenting significant inconvenience in practical use. Furthermore, as previously mentioned, most standard configurations of smart electronic devices now incorporate magnetic elements and wireless charging modules. The design of an electronic device holder disclosed in R.O.C. Utility model M455322, solely provides the support function and fails to meet the user requirements. Obviously, such electronic device holder requires improvements.

In view of the above, the discloser of the present disclosure based on years of experience in the manufacturing, development, and design of related products, meticulously designed and rigorously evaluated the foregoing objectives, and finally provided a feasible solution embodied in the present disclosure.

### SUMMARY OF THE DISCLOSUE

The objective of the present disclosure is to disclose a multifunctional electronic device holder capable of simultaneously accommodating two electronic devices in a planar mode for charging and/or magnetic positioning, as well as switching to an elevation-angle support mode for magnetically positioning and/or charging electronic devices. Furthermore, during the switching between these two operational states, the holder automatically locks into position for user access. When moving the holder, it maintains the newly selected orientation to allow users to choose between charging the electronic device and/or viewing the device screen based on the usage scenarios while preventing the electronic device from falling out from the holder.

To achieve the aforementioned objective, the present disclosure provides a multifunctional electronic device holder, which includes a first carrier board and a second carrier board, and a rotary shaft and a plurality of magnetic positioning elements disposed between the first and second carrier boards.

The first carrier board includes a first load-bearing part located at an end of the top surface of the first carrier board and a first inclined plane located at another end of the top surface of the first carrier board, and the first load-bearing part includes a magnetic element and/or a wireless charging module for magnetically positioning and/or charging an external electronic device.

The second carrier board includes a second load-bearing part located at an end of the top surface of the second carrier board, an inclined plane located at another end of the top surface of

the second carrier board and abutting against the first inclined plane, so that the top surfaces of the first and second carrier boards can be joined together to define a planar support mode, and the second load-bearing part includes a wireless charging module and/or a magnetic element for wirelessly charging and/or magnetically positioning an external electronic device.

The rotary shaft is disposed between the first inclined plane and the second inclined plane and provided for rotating the first carrier board relative to the second carrier board using the rotary shaft as the center to produce an elevation angle of less than 90 degrees between the top surfaces of the first carrier board and the second carrier board, so as to define an elevation-angle support mode. in which an external electronic device abuts against the first load-bearing part.

The plurality of magnetic positioning elements are respectively disposed at corresponding positions between the first inclined plane and the second inclined plane, and when the first and second carrier boards are rotated relative to each other through the rotary shaft to the planar support mode or the elevation-angle support mode, the plurality of magnetic positioning elements are magnetically attracted and positioned relative to each other.

In some embodiments, at least one of the first and second carrier boards includes a wireless charging module provided for charging the external electronic device, and the first or second carrier board includes at least one charging port electrically connected to the wireless charging module on the first or second carrier board.

In some embodiments, the rotary shaft is hollow to allow a power cord to pass between the first and second carrier boards, and the power cord is directly or indirectly electrically connected to the wireless charging module and the charging port on the first and second carrier boards respectively.

The present disclosure also discloses a multifunctional electronic device holder, which includes a first carrier board and a second carrier board, and a rotary shaft and a plurality of limit assemblies disposed between the first and second carrier boards.

The first carrier board includes a first load-bearing part located at an end of the top surface thereof and a first inclined plane located at another end of the top surface thereof, and the first load-bearing part includes a magnetic component and/or a wireless charging module for magnetic positioning and/or charging an external electronic device.

The second carrier board includes a second load-bearing part located at an end of the top surface thereof, an inclined plane located at another end of the top surface thereof and abutting against the first inclined plane, so that the top surfaces of the first and second carrier boards can be joined together to define a planar support mode, and the second load-bearing part includes a wireless charging module and/or a magnetic component for wirelessly charging and/or magnetically positioning an external electronic device.

The rotary shaft is disposed between the first inclined plane and the second inclined plane and provided for rotating the first carrier board relative to the second carrier board using the rotary shaft as the center to produce an elevation angle of less than 90 degrees between the top surfaces of the first carrier board and the second carrier board, so as to define an elevation-angle support mode for an external electronic device to obliquely abut against the first load-bearing part.

The limit assembly is disposed between the first inclined plane and the second inclined plane, and provided for limiting the relative rotation angle of the first and second carrier boards within a range from 0 degree to 180 degrees. when rotating from the planar support mode to the elevation-angle support mode.

Compared to the prior art, the present disclosure achieves the following advantageous effects in addition to enabling the first and second carrier boards to pivot relative to each other to switch between planar support mode and elevation-angle support mode:

The top surfaces of the first and second carrier boards are provided with the first and second load-bearing parts respectively. In the planar support mode, the two load-bearing parts can simultaneously accommodate two different electronic devices for magnetic positioning and/or wireless charging.

When the first and second carrier boards are switched to the planar support mode or the elevation-angle support mode, the plurality of magnetic positioning elements are aligned and magnetically attracted to each other to maintain the configuration between the first and second carrier boards after the switching, so as to prevent displacement of either board when moving the electronic device holder.

When switching to the elevation-angle support mode, the first carrier board forms an elevation angle of less than 90 degrees relative to the second carrier board to allow the magnetic element on the first load-bearing part to magnetically position the electronic device with a magnetically attachable back, so as to prevent the electronic device from falling off when moving the electronic device holder.

In an embodiment where the first carrier board is configured with a wireless charging module, the electronic device magnetically attached to the first load-bearing part can simultaneously undergo wireless charging to enable the electronic device holder to supply power to two different electronic devices at the same time.

When each of the first and second carrier boards is equipped with a wireless charging module, the power cord passes through the hollow section of the rotary shaft, and a limit assembly restricts the relative rotation angle of the first and second carrier boards not exceeding 360 degrees to prevent the power cord from twisting excessively or being damaged, while allowing users to quickly switch the electronic device holder between the planar support mode and the elevation-angle support mode.

The implementation of a power output port on the first or second carrier board not only enables the electronic devices without a wireless charging module to charge through the connection of a power cord, but also allows for the integration of a power storage device within the first or second carrier board, so the present disclosure can simultaneously function as a portable power bank.

The technical characteristics of this disclosure will become apparent with the detailed description of preferred embodiments accompanied with the illustration of related drawings as follows.

### BRIEF DESCRIPTION OF THE DRAWINGS

FIG. 1 is a schematic view of an electronic device holder situated in a planar support mode in accordance with the present disclosure;

FIG. 2 is a disassembled view of an electronic device holder in accordance with the present disclosure;

FIG. 3 is a schematic view of rotating an electronic device holder in accordance with the present disclosure;

FIG. 4 is a schematic view of moving a limit assembly in accordance with the present disclosure;

FIG. 5 is a schematic view of an electronic device holder in an elevation-angle support mode in accordance with the present disclosure;

FIG. 6 is a schematic view of a limit assembly at another position in accordance with the present disclosure;

FIG. 7 is a perspective view of the present disclosure situated at another angle in the elevation-angle support mode;

FIG. 8 is a cross-sectional view of the present disclosure in the elevation-angle support mode.

### DETAILED DESCRIPTION OF THE DISCLOSURE

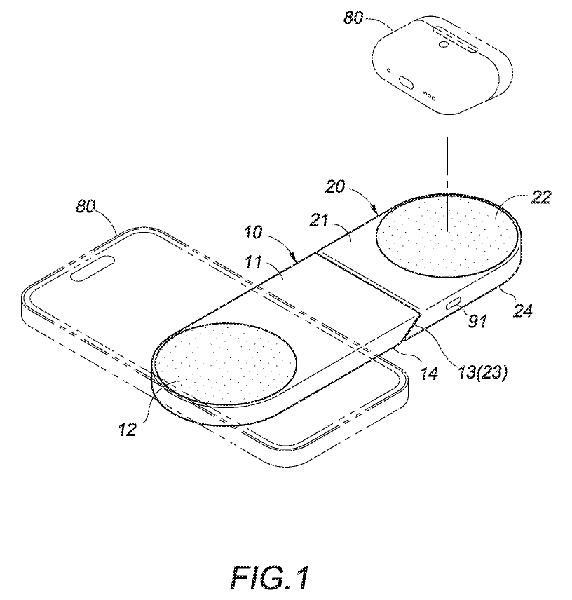

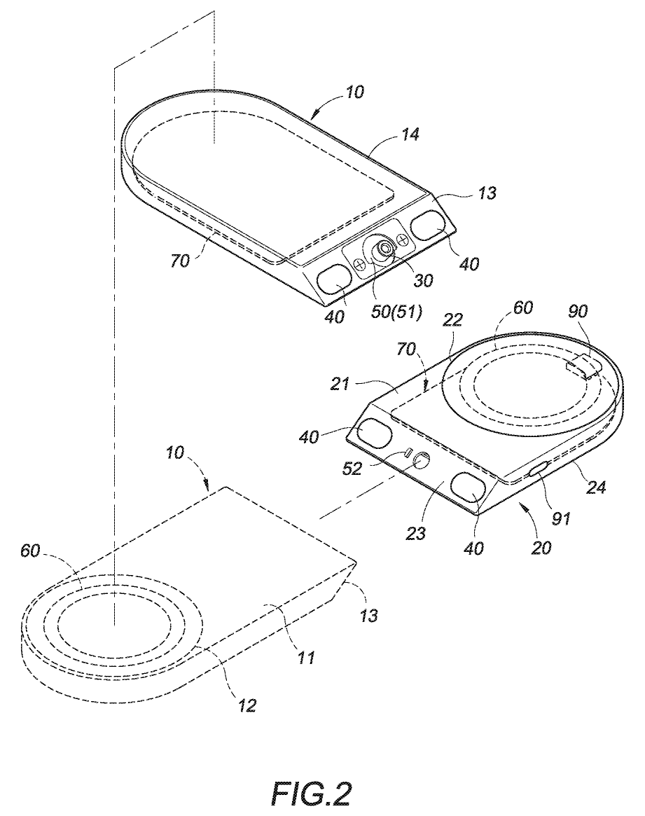

With reference to FIGS. 1 and 2 for a multifunctional electronic device holder of the present disclosure, the basic structure of the multifunctional electronic device holder includes a first carrier board 10, a second carrier board 20, and a rotary shaft 30, a plurality of magnetic positioning elements 40 and/or a limit assembly 50 disposed between the first and second carrier boards 10, 20, so that the first and second carrier boards 10, 20 can be positioned after being rotated relative to each other.

The first carrier board 10 is generally flat in shape, with a first load-bearing part 12 disposed at an end of its top surface 11 and a first inclined plane 13 disposed at the other end. The first load-bearing part 12 is at least provided with a magnetic element 60 and/or a wireless charging module 70.

The second carrier board 20 is similarly configured as a flat plates, with a second load-bearing part 22 disposed at an end of its top surface 21, while a second inclined plane 23 disposed at another end and configured to be corresponding to the angle of the first inclined plane 13. The second load-bearing part 22 is provided with at least one wireless charging module 70 and/or a magnetic element 60.

When the first inclined plane 13 of the first carrier board 10 and the second inclined plane 23 of the second carrier board 20 are joined with each other, their top surfaces 11 and 21 can be joined together to form the planar support mode as shown in FIG. 1. while their bottom surfaces 14, 24 can rest on a tabletop or any flat surface. The first and second load-bearing parts 12, 22 can accommodate two different external electronic devices 80 respectively.

Taking FIGS. 1 and 2 as examples, the first load-bearing part 12 incorporates a magnetic element 60 to enable the placement and positioning of an electronic device 80 with a magnetically attachable back, such as the mobile phone as shown in the figures. The second load-bearing part 22 is provided with a wireless charging module 70 to allow charging of an electronic device 80 with a wireless charging function. such as a smartwatch or a Bluetooth headphone as shown in the figures.

It is understood that the first load-bearing part 12 of the first carrier board 10 may further incorporate a wireless charging module 70 to enable wireless charging of the external electronic device 80 when magnetically positioned. For example, this could accommodate a smartphone equipped with both magnetic positioning and wireless charging functions.

Similarly, the second load-bearing part 22 of the second carrier board 20 may also be provided with a magnetic element 60 to enable magnetic positioning and charging of an external electronic device 80 that simultaneously incorporates magnetic attraction and wireless charging function, such as a smartwatch having both functions.

Of course, during implementation, it is not excluded that both the first and second load-bearing parts 12, 22 may simultaneously incorporate the magnetic element 60 or wireless charging module 70 to allow manufacturers or users to select according to their needs.

Additionally, in the embodiment where the wireless charging module 70 is configured on at least one of the first or second carrier boards 10, 20, at least one charging port 90 may be provided on the first or second carrier board 10, 20, and the charging port 90 is electrically connected to the wireless charging module 70 to accommodate the electrical connector of an external power supply such as a USB Type-C connector for power supply.

In addition to the charging port 90, a power output port 91 may also be provided on either the first or second carrier board 10, 20 to enable an external electronic device 80 to be charged through the connection of the power cord connection. It is noteworthy that if a power storage device (not shown in the figure) is installed in the first or second carrier board 10, 20, and the power storage device is electrically connected to the charging port 90, the power output port 91, and the wireless charging module 70 respectively to enable the power storage device to perform power input storage and output power supply, so that the multifunctional electronic device of the present disclosure can also serve as a power bank to expand its capabilities and scope of application.

Therefore, in the planar support mode, the present disclosure utilizes the first and second carrier boards 10, 20, specifically their top surfaces 11, 21 and first and second load-bearing parts 12, 22, to accommodate and position two different electronic devices 80 simultaneously for magnetic positioning and/or wireless charging.

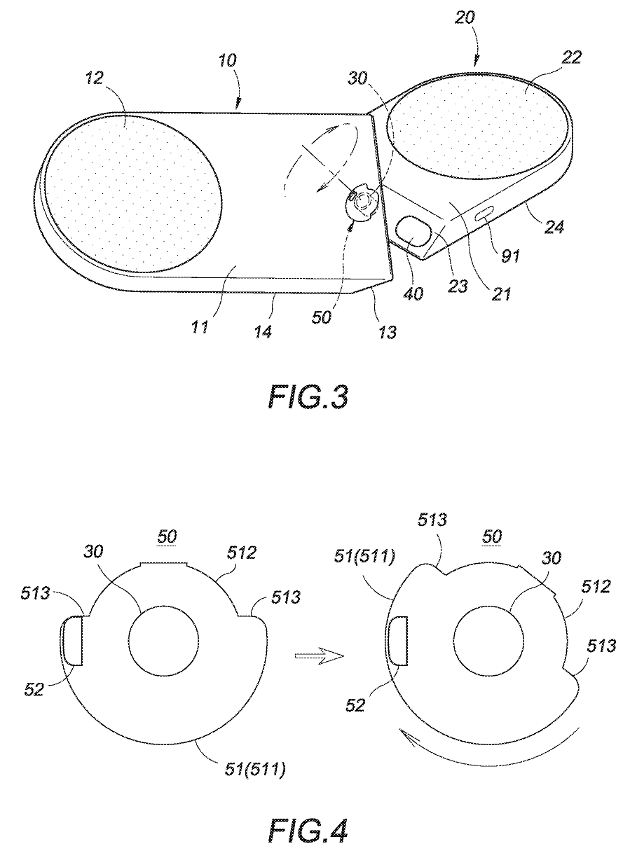

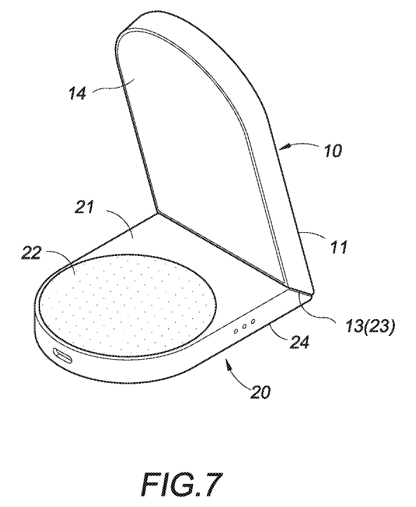

As shown in FIGS. 2 to 7, the rotary shaft 30 is disposed between the first inclined plane 13 and the second inclined plane 23 of the first and second carrier boards 10, 20 to enable the first carrier board 10 to be rotated relative to the second carrier board 20 using the rotary shaft 30 as the center. Since the first inclined plane 13 and the second inclined plane 23 abut against each other and have corresponding angles, when the first carrier board 10 rotates 180 degrees, the top surface 11 of the first carrier board 10 can produce an elevation angle of less than 90 degrees relative to the second carrier board 20, thereby defining an elevation-angle support mode.

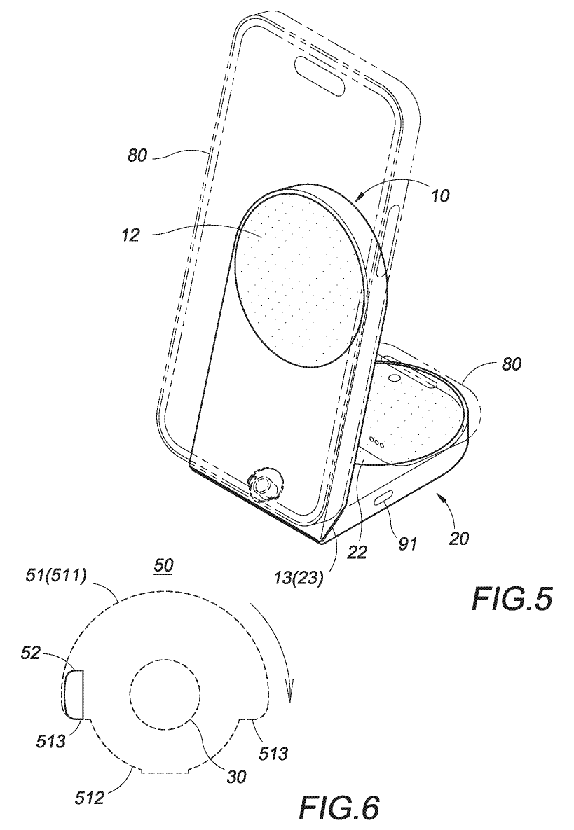

When the first and second carrier boards 10, 20 form an elevation-angle support mode, as shown in FIGS. 2 and 5, in the embodiment where a magnetic element 60 is provided on the first load-bearing part 12, the inclined first load-bearing part 12 allows an electronic device 80 with a magnetically attachable back to be magnetically positioned at an angle. such as the mobile phone as shown in the figures to enable the screen of the mobile phone to present a slightly elevation-angled view for user observation and operation. Furthermore, during operation, the magnetic attraction prevents the device from falling off from the first carrier board 10.

Of course, if the first load-bearing part 12 is provided with both the magnetic element 60 and the wireless charging module 70, the mobile phone can undergo wireless charging while being magnetically positioned. Furthermore, in the embodiment where the second load-bearing part 22 incorporates a wireless charging module 70, it can simultaneously charge another electronic device 80 with a wireless charging function, thereby achieving multifunctional capabilities.

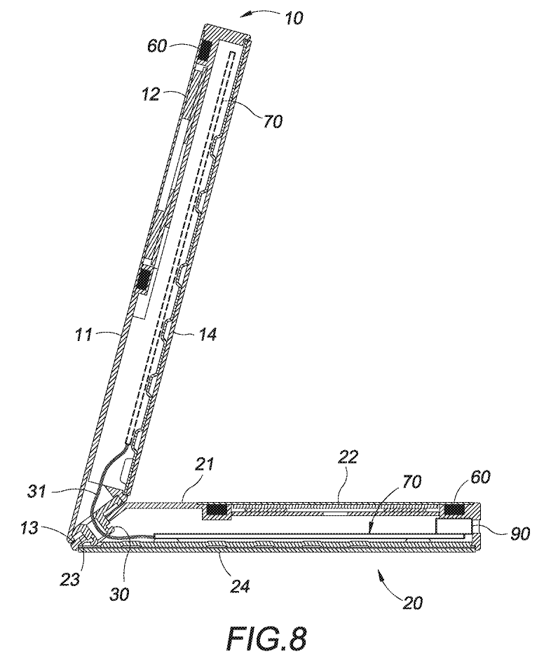

In the aforementioned embodiment as shown in FIGS. 2 and 8, , when both the first and second load-bearing parts 12, 22 are equipped with the wireless charging modules 70, the rotary shaft 30 may be designed in a hollow shape to allow the power cord 31 to pass through between the first and second carrier boards 10, 20, and the power cord 31 is directly or indirectly electrically connected to the wireless charging module 70 and the charging port 90 on the first and second carrier boards 10, 20 respectively, thereby allowing the two wireless charging modules 70 to share a plurality of charging ports 90 for power supply.

The primary function of the aforementioned magnetic positioning element 40 is to position the first and second carrier boards 10, 20 after they are switched to either the planar support mode or the elevation-angle support mode.

As shown in FIGS. 2, 3, 5, and 8, the magnetic positioning elements 40 are respectively positioned at corresponding positions between the first inclined plane 13 and the second inclined plane 23. For example, the magnetic positioning element 40 includes a magnet mounted on the first inclined plane 13 and a magnetic metal (such as an iron sheet) mounted on the second inclined plane 23.

Therefore, when the first and second carrier boards 10, 20 are in the planar support mode, the first and second inclined planes 13, 23 can be magnetically positioned relative to each other through the magnetic positioning elements 40. When the first and second carrier boards 10, 20 are rotated relative to each other, the magnetic positioning elements 40 on the first and second inclined planes 13, 23 are separated from each other, until the first and second carrier boards 10, 20 are switched to the elevation-angle support mode. At this point, the plurality of magnetic positioning elements 40 are magnetically engaged again to maintain the configuration established after the switching from the support mode, so as to prevent relative deflection of the first carrier board 10 or second carrier board 20 due to gravity when moving the electronic device holder, which could cause the electronic device 80 magnetically attached to the first carrier board 10 to fall off from the electronic device holder.

It is noteworthy that in the embodiment where the wireless charging modules 70 are mounted on the first and second carrier boards 10, 20 respectively to prevent the power cord 31 from twisting excessively when switching between the two operational modes, a limit assembly 50 may be provided between the first and second inclined planes 13, 23 to restrict the rotation angle of the first and second carrier boards 10, 20 to less than 360 degrees. Furthermore, the limit assembly 50 can also position the first and second carrier boards 10, 20 during the switching between the planar support mode and the elevation-angle support mode.

As shown in FIGS. 2 to 6 and 8, the limit assembly 50 includes an arc-shaped limiting groove 51 disposed on the first inclined plane 13 or the second inclined plane 23, and a corresponding limiting bump 52 disposed on the second inclined plane 23 or the first inclined plane 13, and the limiting bump 52 is embedded in the arc-shaped limiting groove 51.

Taking the arc-shaped limiting groove 51 disposed on the first inclined plane 13 and the limiting bump 52 disposed on the second inclined plane 23 as an example, the limiting groove 51 surrounds the outer periphery of the rotary shaft 30, and includes a semicircular first recess 511 and a semicircular second recess 512 with an inner diameter smaller than the first recess 511. The junction points at both ends of the first and second recesses 511, 512 form two stop parts 513 that can engage and limit the position of the limiting bump 52.

When the first carrier board 10 is rotated relative to the second carrier board 20, the arc-shaped limiting groove 51 is rotated accordingly. and when the stop part 513 at an end of the arc-shaped limiting groove 51 abuts against the limiting bump 52, the relative rotation angle of the first carrier board 10 and the second carrier board 20 is restricted to an angle not exceeding 360 degrees, thereby preventing the power cord 31 from twisting excessively.

As described above, the limit assembly 50 can also position the first and second carrier boards 10, 20 during the switching between the planar support mode and the elevation-angle support mode. For example, the semicircular first recess 511 and the semicircular second recess 512 with a larger inner diameter in the limit assembly 50 (as shown in the figure) position two stop parts 513 at their respective junction points. These stop parts 513 precisely restrict the relative rotation angle between the first and second carrier boards 10, 20 to 180 degrees.

For example, when the first and second carrier boards 10, 20 are in the planar support mode, the stop part 513 at an end of the arc-shaped limiting groove 51 abuts against the limiting bump 52, with this position set as 0 degree; When a user rotates the first carrier board 10 by 180 degrees, causing the other stop part 513 of the arc-shaped limiting groove 51 to abut against the limiting bump 52, the mode is precisely switched from the planar support mode at 0 degrees to the elevation-angle support mode at 180 degrees. and vice versa. This allows the user to intuitively switch between the planar support mode and the elevation-angle support mode for positioning.

In the implementation of this positioning function, it is not excluded that the arc-shaped limiting groove 51 may be configured as a 180-degree semicircular groove (not shown in the figure), with elastic retaining points or friction damping elements provided at both ends of the stop part 513 respectively, to enable the first and second carrier boards 10, 20 to be positioned for both planar support mode and elevation-angle support mode, thereby replacing or enhancing the positioning function of the magnetic positioning element 40.

The description above pertains only to the preferred embodiments of the present invention. However, the structural features of the invention are not limited thereto. Any variation or modification readily conceivable by those skilled in the art within the scope of the present invention shall be encompassed within the scope of the appended claims.

What is claimed is:

1. A multifunctional electronic device holder, comprising a first carrier board and a second carrier board, and a rotary shaft and a plurality of magnetic positioning elements disposed between the first and second carrier boards; wherein:
the first carrier board comprises a first load-bearing part located at an end of the top surface thereof and a first inclined plane located at another end of the top surface thereof, and the first load-bearing part comprises a magnetic element and/or a wireless charging module for magnetic positioning and/or charging an external electronic device;
the second carrier board comprises a second load-bearing part located at an end of the top surface thereof, an inclined plane located at another end of the top surface thereof and abutting against the first inclined plane, so that the top surfaces of the first and second carrier boards can be joined together to define a planar support mode, and the second load-bearing part comprises a wireless charging module and/or a magnetic element for wirelessly charging and/or magnetically positioning an external electronic device;
the rotary shaft is disposed between the first inclined plane and the second inclined plane and provided for rotating the first carrier board relative to the second carrier board using the rotary shaft as the center to produce an elevation angle of less than 90 degrees between the top surfaces of the first carrier board and the second carrier board, so as to define an elevation-angle support mode in which an external electronic device abuts against the first load-bearing part; and
the plurality of magnetic positioning elements are respectively disposed at corresponding positions between the first inclined plane and the second inclined plane, and when the first and second carrier boards are rotated relative to each other through the rotary shaft to the planar support mode or the elevation-angle support mode, the plurality of magnetic positioning elements are magnetically attracted and positioned relative to each other.

2. The multifunctional electronic device holder according to claim 1, wherein at least one of the first and second carrier boards comprises a wireless charging module provided for charging the external electronic device, and the first or second carrier board comprises at least one charging port electrically coupled to the wireless charging module on the first or second carrier board.

3. The multifunctional electronic device holder according to claim 2, wherein the first or second carrier board comprises a power storage device disposed therein and electrically coupled to the charging port and the wireless charging module.

4. The multifunctional electronic device holder according to claim 3, wherein each of the first and second carrier boards is provided with a wireless charging module, the rotary shaft is hollow to allow a power cord to pass between the first and second carrier boards, and the power cord is directly or indirectly electrically coupled to the wireless charging module and the charging port on the first and second carrier boards respectively.

5. The multifunctional electronic device holder according to claim 4, wherein a limit assembly is arranged between the first inclined plane and the second inclined plane for limiting the relative rotation angle of the first and second carrier boards not exceeding 360 degrees to prevent the power cord from twisting excessively.

6. The multifunctional electronic device holder according to claim 3, wherein the first or second carrier board further comprises a power output port provided for plugging and charging the external electronic device.

7. The multifunctional electronic device holder according to claim 2, wherein each of the first and second carrier boards comprises a wireless charging module, the rotary shaft is hollow to allow a power cord to pass between the first and second carrier boards, and the power cord is directly or indirectly electrically coupled to the wireless charging module and the charging port on the first and second carrier boards respectively.

8. The multifunctional electronic device holder according to claim 7, wherein a limit assembly is arranged between the first inclined plane and the second inclined plane for limiting the relative rotation angle of the first and second carrier boards not exceeding 360 degrees to prevent the power cord from twisting excessively.

9. The multifunctional electronic device holder according to claim 2, wherein the first or second carrier board further comprises a power output port for plugging and charging the external electronic device.

10. A multifunctional electronic device holder, comprising a first carrier board and a second carrier board, and a rotary shaft and a plurality of limit assemblies disposed between the first and second carrier boards, wherein:
the first carrier board comprises a first load-bearing part located at an end of the top surface thereof and a first inclined plane located at another end of the top surface thereof, and the first load-bearing part comprises a magnetic element and/or a wireless charging module for magnetic positioning and/or charging an external electronic device;
the second carrier board comprises a second load-bearing part located at an end of the top surface thereof, an inclined plane located at another end of the top surface thereof and abutting against the first inclined plane, so that the top surfaces of the first and second carrier boards can be joined together to define a planar support mode, and the second load-bearing part comprises a wireless charging module and/or a magnetic element for wirelessly charging and/or magnetically positioning an external electronic device;
the rotary shaft is disposed between the first inclined plane and the second inclined plane and provided for rotating the first carrier board relative to the second carrier board using the rotary shaft as the center to produce an elevation angle of less than 90 degrees between the top surfaces of the first carrier board and the second carrier board, so as to define an elevation-angle support mode in which an external electronic device abuts against the first load-bearing part; and
the limit assembly is disposed between the first inclined plane and the second inclined plane, and provided for limiting the relative rotation angle of the first and second carrier boards within a range from 0 degrees to 180 degrees, when rotating from the planar support mode to the elevation-angle support mode.

11. The multifunctional electronic device holder according to claim 10, wherein the limit assembly comprises an arc-shaped limiting groove disposed on the first inclined plane or the second inclined plane, and a corresponding limiting bump disposed on the second inclined plane or the first inclined plane, and the limiting bump is embedded in the arc-shaped limiting groove, so that when the first and second carrier boards are rotated relative to each other, the arc-shaped limiting groove or the limiting bump is rotated accordingly until the limiting bump abuts against one of the ends of the arc-shaped limiting groove to limit the rotation angle between the first and second carrier boards.

12. The multifunctional electronic device holder according to claim 11, wherein the limiting groove surrounds the rotary shaft and comprises a semicircular first recess and a semicircular second recess with an inner diameter smaller than the first recess, and a stop part is formed at the junction points of two ends of the first and second recesses and provided for the abutment and position limiting made by the limiting bump.

13. The multifunctional electronic device holder according to claim 12, further comprising a plurality of magnetic positioning elements disposed at corresponding positions between the first inclined plane and the second inclined plane, and magnetically attracted and positioned relative to each other when the first and second carrier boards are rotated relative to each other through the rotary shaft to the planar support mode or the elevation-angle support mode.

14. The multifunctional electronic device holder according to claim 11, further comprising a plurality of magnetic positioning elements disposed at corresponding positions between the first inclined plane and the second inclined plane, and magnetically attracted and positioned relative to each other when the first and second carrier boards are rotated relative to each other through the rotary shaft to the planar support mode or the elevation-angle support mode.

15. The multifunctional electronic device holder according to claim 10, further comprising a plurality of magnetic positioning elements disposed at corresponding positions between the first inclined plane and the second inclined plane, and magnetically attracted and positioned relative to each other when the first and second carrier boards are rotated relative to each other through the rotary shaft to the planar support mode or the elevation-angle support mode.
